(19) United States
(12) Patent Application Publication
(10) Pub. No.: US 2011/0061009 A1
(43) Pub. Date: Mar. 10, 2011

(54) FLEXIBLE USER INTERFACE FOR IMAGE MANIPULATION FOR AN IAMGE PRODUCT

(76) Inventors: John David Poisson, San Francisco, CA (US); Kevin Mercer Twohy, La Canada, CA (US)

(21) Appl. No.: 12/683,557

(22) Filed: Jan. 7, 2010

Related U.S. Application Data
(60) Provisional application No. 61/265,643, filed on Dec. 1, 2009.
(60) Provisional application No. 61/241,354, filed on Sep. 10, 2009.

(51) Int. Cl. G06F 3/048; G06F 3/041

(52) U.S. Cl. 715/764; 345/173

(57) ABSTRACT

A computer-assisted method for automatically creating a picture strip at a user interface includes the steps of displaying a template for a picture strip having one or more image receiving areas in a user interface on a display device, placing an image in one of the image receiving areas in the template in the user interface, displaying a circle around the image by the display device, displaying a handle in association with the circle by the display device, and allowing a user drag the handle to rotate and scale the image in the one of the image receiving areas.

### CROSS-REFERENCES TO RELATED INVENTIONS

The present invention claims priority to U.S. Provisional Patent Application Ser. No. 61/265,643, titled “Flexible user interface for image manipulation for an image product”, filed Dec. 1, 2009, by the same inventors, and U.S. Provisional Patent Application Ser. No. 61/241,354, titled “Wireless imaging for personalized image product”, filed Sep. 10, 2009, the disclosures of which are incorporated herein by reference.

### BACKGROUND OF THE INVENTION

In recent years, photography has been rapidly transformed by digital imaging technologies. Digital images can be captured by digital cameras or camera phones, stored in computers, and viewed on electronic display devices. Digital images can be uploaded from a user's computer device to a central sever provided by an image service provider such as Shutterfly, Inc. The user can store, organize, edit, enhance, and share digital images at the central network location using a web browser. A user can also design and order image-based products from the image service provider for the user herself or as photo gifts to others. A high degree of personalization can be achieved to make the image-based products memorable to the user and to the photo gift recipients.

The creation of personalized image products, however, can take considerable amount of time and effort. In addition, user interface for creating personalized image products are not available on small mobile devices on wireless camera phones. There is therefore a need for more convenient methods for creating personalized imaging products on camera phone and other digital imaging devices.

### SUMMARY OF THE INVENTION

In one aspect, the present application relates to a computer-assisted method for automatically creating a picture strip at a user interface. The method includes displaying a template for a picture strip having two or more image receiving areas in a user interface on a display device; placing an image in one of the image receiving areas in the template in the user interface; displaying a circle around the image by the display device; displaying a handle in association with the circle by the display device; and allowing a user to drag the handle to rotate and to scale the image in the one of the image receiving areas.

Implementations of the system may include one or more of the following. The image can be rotated by dragging and moving the handle at least partially along the circular direction of the circle. The image can be scaled by dragging and moving the handle at least partially along the radial direction of the circle. The computer-assisted method can further include dragging and translating the image in the one of the image receiving areas to allow different portions of the image to be viewable in the one of image receiving areas. The computer-assisted method can further include displaying a delete button to allow a use to remove the image from the one of image receiving areas by touching the delete button. The computer-assisted method can further include determining the borders of the image at each orientation and position of the image; comparing the borders of the image to the borders of the one of image receiving areas; and selecting the size of the image to allow the one of image receiving areas to be fully occupied by a portion of the image. The size of the image can be selected at above a minimum size such that the one of image receiving areas is fully occupied by a portion of the image.

In another aspect, the present application relates to a computer-assisted method for automatically creating an image product at a user interface. The method includes displaying a template for an image product having an image receiving area in a user interface on a display device; placing an image in the image receiving area in the template in the user interface; displaying a circle around the image by the display device; displaying a handle in association with the circle by the display device; allowing a user to drag the handle at least partially along the circular direction of the circle to rotate the image in the image receiving area; and allowing a user to drag the handle at least partially along the radial direction of the circle to change the size of the image.

In another aspect, the present application relates to a computer device for automatically creating an image product at a user interface. The computer device includes a display device that can display a template for an image product having an image receiving area in a user interface on a display device; and a user-interface mechanism that can allow an image to be placed in the image receiving area in the template in the user interface, wherein the display device can display a circle around the image by the display device, a handle in association with the circle by the display device, wherein the display device and the user-interface mechanism allow a user to drag the handle at least partially along the circular direction of the circle to rotate the image in the image receiving area and to drag the handle at least partially along the radial direction of the circle to change the size of the image.

Implementations of the system may include one or more of the following. The display device and the user-interface mechanism can allow a user to drag and translate the image in the image receiving area to allow different portions of the image to be viewable in the image receiving area. The display device can display a delete button to allow a use to remove the image from the image receiving area by touching the delete button. The computer device can further include a computer processor that can determine the borders of the image at each orientation and position of the image, to compare the borders of the image to the borders of the image receiving area, and to select the size of the image to allow the image receiving area to be fully occupied by a portion of the image. The computer processor can select size of the image at above a minimum size such that the image receiving area is fully occupied by a portion of the image.

Embodiments may include one or more of the following advantages. The disclosed systems and methods provide a flexible system and user interface to allow a user to manipulate an image in an image template for creating an image-based product. A user can easily rotate and scale an image in the image template by controlling a single feature in the user interface. Specifically, a user can drag a single handle with a mouse or a touch sensitive screen to rotate the image as well as to change the size of the image. The rotation and size-changing functions can be assisted by a guideline such as a circle around the image.

In another aspect, the disclosed systems and methods provide a convenient way for a camera phone user to create and order image-based gifts for another wireless phone user without knowing the recipient's physical address.

The disclosed systems and methods can significantly reduce the time and effort for a user to create a personalized image product. The disclosed systems and methods also provide a novel imaging product format that can be easily carried and shared by users.

### BRIEF DESCRIPTION OF THE DRAWINGS

FIG. 1 illustrates an exemplified format of a personalized picture strip.

FIG. 2A-2F illustrate a novel user interface for manipulating images in a picture strip.

FIG. 3 illustrates the flexible features for rotating and scaling the image in the user interface.

FIG. 4 illustrates an application of the user interface on a mobile phone.

FIG. 5 illustrates an application of the user interface at a web site.

Although the invention has been particularly shown and described with reference to multiple embodiments, it will be understood by persons skilled in the relevant art that various changes in form and details can be made therein without departing from the spirit and scope of the invention.

### DETAILED DESCRIPTION OF THE INVENTION

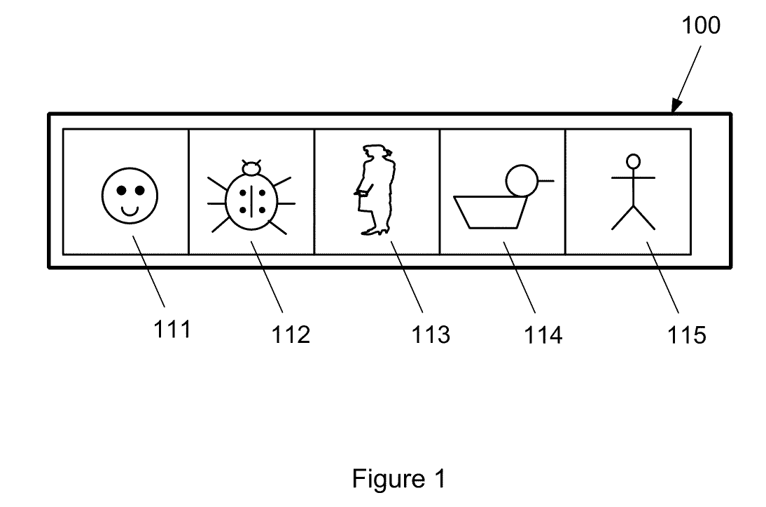

FIG. 1 shows an exemplified image based product compatible with the present invention. A picture strip 100 has a convenient slender print format. The picture strip 100 can have slender dimensions of 2″×5″, 2″×6″, 1.5″ by 4″, and so on, and an aspect (length to width) ratio in the range from about 2.5:1 to about 6:1. The picture strip can be produced a photosensitive paper, a plain paper, a substrate comprising synthetic materials such as a plastic sheet, a glass sheet, and a metal substrate. The picture strip 200 is narrower and have a higher aspect ration compared to traditional 3R (3.5″ by 5″), 4R (4″ by 6″), and 5R (5″ and 7″) print formats

The slender formats of the picture strip 100 make it easily carried around in a pocket, wallet, or inserted in a book or a note book. The format of the picture strip 100 is suitable for displaying a row of tiny images 111-115 in a group. These tiny pictures can display images captured by camera phones because some camera phones do not have large image sensors that can produce digital images at high enough resolutions for large image prints. Moreover, the users of camera phones with large image sensors may want to reduce the amount of the data wireless transferred by uploading a downsized version of the captured image to a network-based imaging system.

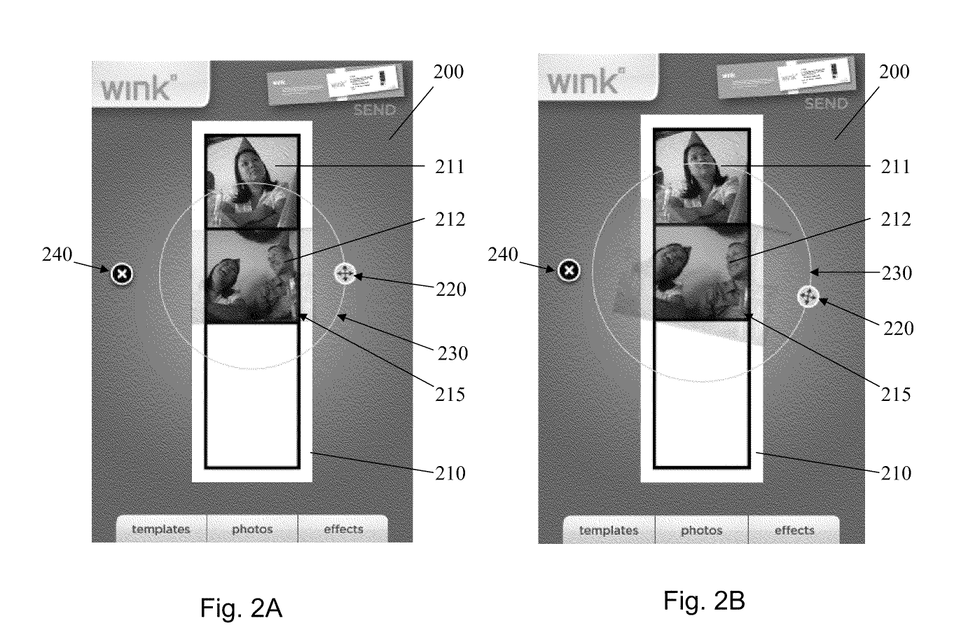

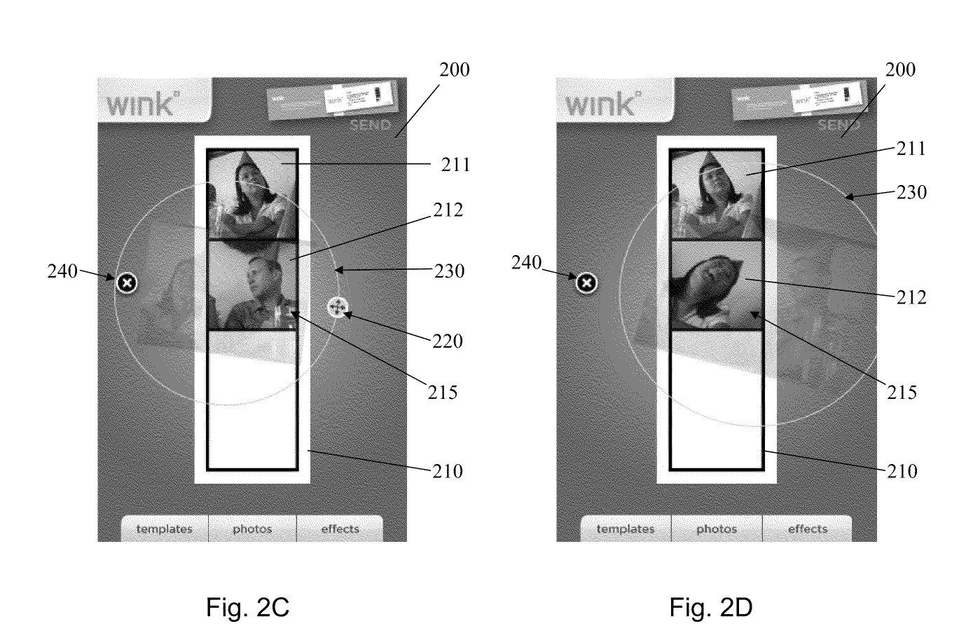

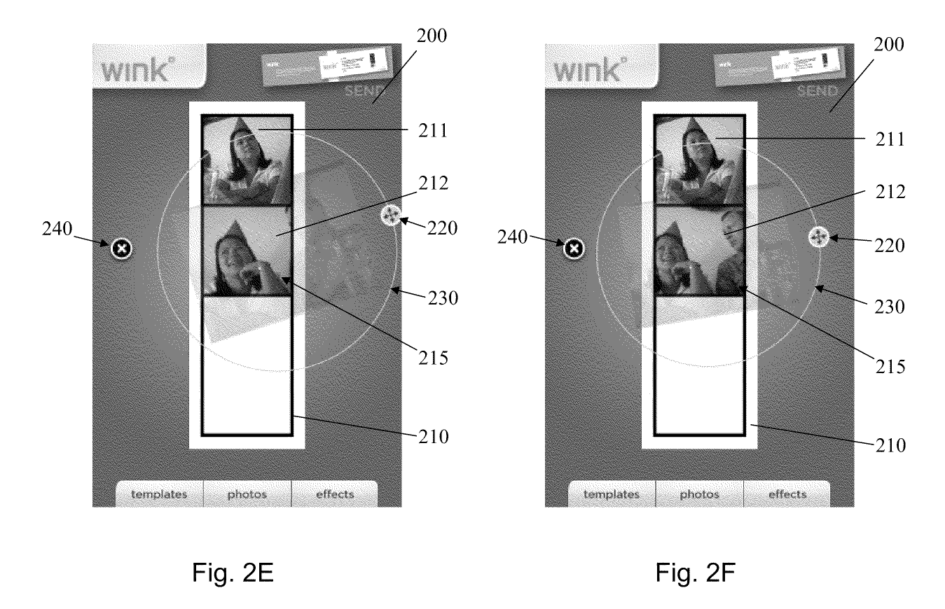

Referring to FIGS. 2A-2F, a user interface 200 includes a template 210 for a picture strip. The template 210 includes image receiving areas (e.g. 215) configured to receive images 211 and 212. A user, for example, can use a mouse drag images 211 and 212 from different areas of the user interface into the image receiving areas in the image template 210. A use can also double click the image area 215 which prompts the appearance of a window to allow an image to be selected.

When an image such as the image 212 is selected in the template 210, a handle 220 and a circle 230 appear in the user interface 200. The circle 230 surrounds the image 212. The handle 220 is positioned on the circle. A user can drag the handle 220 to move along the circular direction of the circle 230 to rotate the image 212. As a result, the image 212 at the center of the circle 230 is rotated from the orientation shown in FIG. 2A to that shown in FIG. 2B. The user can also move the image along the radial direction to enlarge or reduce the circle 230 as well as the image 212 (FIGS. 2D and 2E). In the present application, the term “scale” or “scaling” refers to changing the size of an image, which may include enlarging or reducing the size of the image.

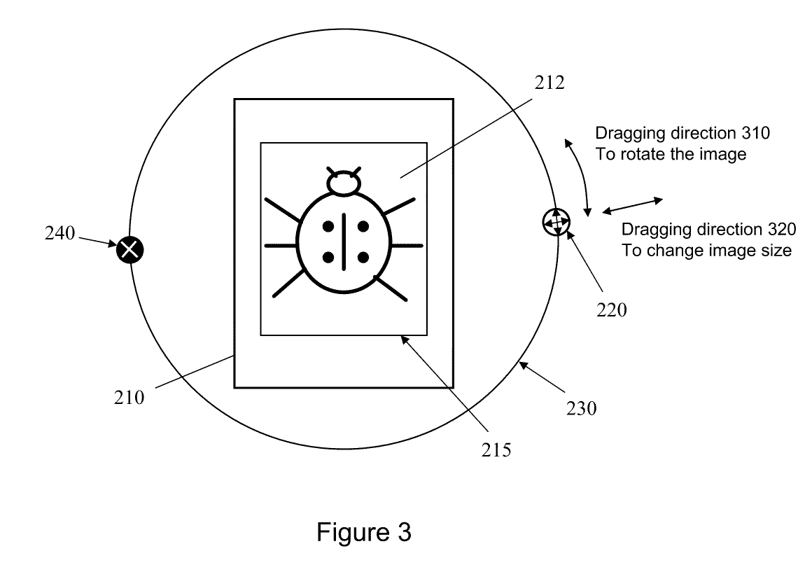

The directions for dragging the handle 220 are illustrated in more detail in FIG. 3. The image 215 can be rotated in the image receiving area 215 by dragging and moving the handle along a substantially circular direction 310. The size of the image 215 can be changed by dragging and moving the handle along a substantially radial direction 320. It should be noted that by dragging the handle 220 a user can rotate and scale an image at the center of the circle 230 simultaneously. The dragging of the handle 220 can be achieved by a finger touching the handle on a touch sensitive screen or using a mouse to grab the handle 220.

The user can also directly drag the image 212 to translate the image to move different portions of the image 212 into view in the template 210 (FIGS. 2C-2F). The user can select different images 211, 212 in the image template 210 to rotate, scale, and translate the better image portions in the most desirable orientation in the image receiving areas.

When an image 211 or 212 is selected, the user interface 200 can also show a delete button 240 next to the selected image. A user can touch the delete button to remove the image 212 from the image receiving area 215.

In another novel aspect of the present invention, the blank gaps can be avoided in an image receiving area as an image is rotated in the image receiving area. As shown in FIGS. 2B, 2C, and 2F, the radius of the circle 230 and thus the image 212 can sometimes be scaled to be too small such as the image 212 could not fully cover the image receiving area 215. In such cases, the disclosed system and user interface can automatically limit the minimum size of the image 212 at each orientation and position such that only image areas of the image 212 is shown in the image receiving area 215. In other words, no blank gaps without image content are allowed to appear in the image receiving area 215 (e.g. at the corners). The process described involves determining the borders of the image at each orientation and position of the image 212, comparing the borders of the image 212 to the borders of the image receiving area 215, and selecting the size of the image 212 at above a minimum size such that the image receiving area 215 is fully occupied by a portion of the image 212.

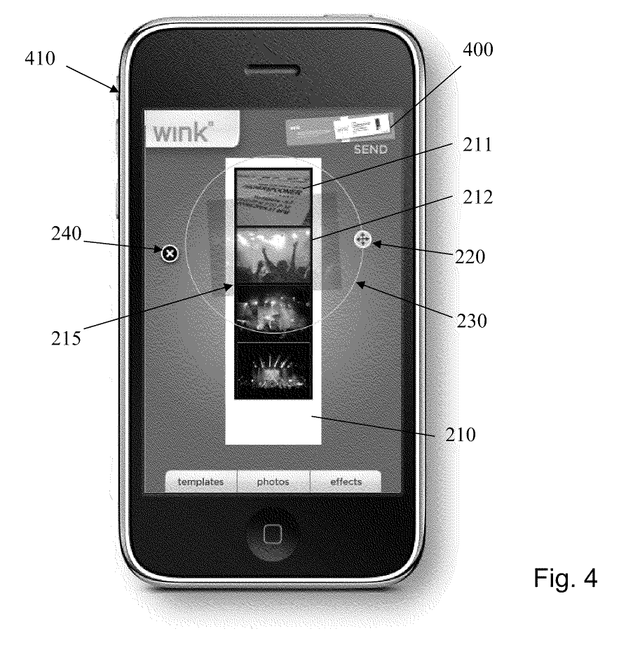

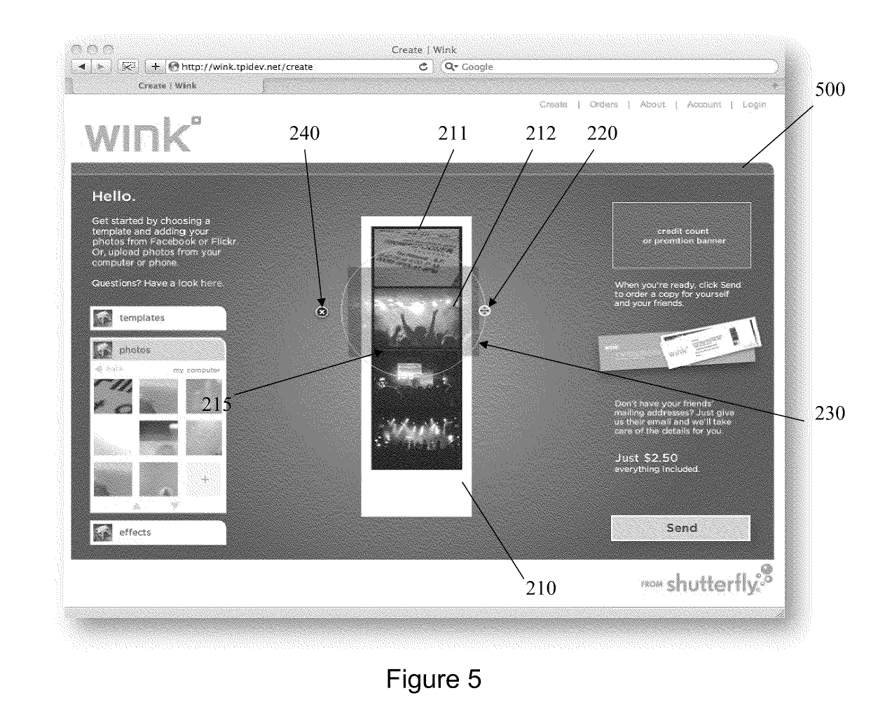

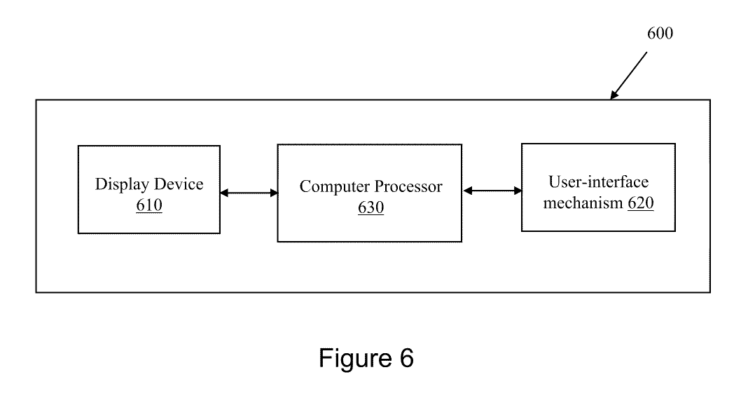

FIG. 4 illustrates a user interface 400 on a computer device 410 having similar functions as described above. The computer device 410 can for example be a mobile device such as a smart phone. FIG. 5 illustrates a user interface 500 on a web user interface at a web site, which can be displayed on a computer device such as a personal computer, a laptop or tablet computer, a mobile device such as a smart phone etc. The user interface 500 can include similar functions as described above.

As shown in FIG. 6, a computer device 600 compatible with the presently disclosed methods and system can include a display device 610 such as a liquid crystal display that can display a template for an image product having an image receiving area in a user interface on a display device. A user-interface mechanism 620, such as a mouse or a touch-sensitive screen, allows an image to be placed in the image receiving area in the template in the user interface. The display device 610 can display a circle around the image by the display device, a handle in association with the circle by the display device. The display device 610 and the user-interface mechanism 620 allow a user to drag the handle at least partially along the circular direction of the circle to rotate the image in the image receiving area and to drag the handle at least partially along the radial direction of the circle to change the size of the image. The display device 610 and the user-interface mechanism 620 allow a user to drag and translate the image in the image receiving area to allow different portions of the image to be viewable in the image receiving area. The display device 610 can display a delete button to allow a use to remove the image from the image receiving area by touching the delete button. The computer device 600 also includes a computer processor 630 that can computationally determine the borders of the image at each orientation and position of the image, to compare the borders of the image to the borders of the image receiving area and select the size of the image to allow the image receiving area to be fully occupied by a portion of the image. The computer processor 630 can select size of the image at above a minimum size such that the image receiving area is fully occupied by a portion of the image.

What is claimed is:

1. A computer-assisted method for automatically creating a picture strip at a user interface, comprising:
displaying a template for a picture strip having two or more image receiving areas in a user interface on a display device;
placing an image in one of the image receiving areas in the template in the user interface;
displaying a circle around the image by the display device;
displaying a handle in association with the circle by the display device; and
allowing a user to drag the handle to rotate and to scale the image in the one of the image receiving areas.

2. The computer-assisted method of claim 1, wherein the image is rotated by dragging and moving the handle at least partially along the circular direction of the circle.

3. The computer-assisted method of claim 1, wherein the image is scaled by dragging and moving the handle at least partially along the radial direction of the circle.

4. The computer-assisted method of claim 1, further comprising:
dragging and translating the image in the one of the image receiving areas to allow different portions of the image to be viewable in the one of image receiving areas.

5. The computer-assisted method of claim 1, further comprising:
displaying a delete button to allow a use to remove the image from the one of image receiving areas by touching the delete button.

6. The computer-assisted method of claim 1, further comprising:
determining the borders of the image at each orientation and position of the image;
comparing the borders of the image to the borders of the one of image receiving areas; and
selecting the size of the image to allow the one of image receiving areas to be fully occupied by a portion of the image.

7. The computer-assisted method of claim 6, wherein the size of the image is selected at above a minimum size such that the one of image receiving areas is fully occupied by a portion of the image.

8. A computer-assisted method for automatically creating an image product at a user interface, comprising:
displaying a template for an image product having an image receiving area in a user interface on a display device;
placing an image in the image receiving area in the template in the user interface;
displaying a circle around the image by the display device;
displaying a handle in association with the circle by the display device;
allowing a user to drag the handle at least partially along the circular direction of the circle to rotate the image in the image receiving area; and
allowing a user to drag the handle at least partially along the radial direction of the circle to change the size of the image.

9. The computer-assisted method of claim 8, further comprising:
dragging and translating the image in the image receiving area to allow different portions of the image to be viewable in the image receiving area.

10. The computer-assisted method of claim 8, further comprising:
displaying a delete button to allow a use to remove the image from the image receiving area by touching the delete button.

11. The computer-assisted method of claim 8, further comprising:
determining the borders of the image at each orientation and position of the image;
comparing the borders of the image to the borders of the image receiving area; and
selecting the size of the image to allow the image receiving area to be fully occupied by a portion of the image.

12. The computer-assisted method of claim 11, wherein the size of the image is selected at above a minimum size such that the image receiving area is fully occupied by a portion of the image.

13. A computer device for automatically creating an image product at a user interface, comprising:
a display device configured to display a template for an image product having an image receiving area in a user interface on a display device; and
a user-interface mechanism configured to allow an image to be placed in the image receiving area in the template in the user interface, wherein the display device is configured to display a circle around the image by the display device, a handle in association with the circle by the display device, wherein the display device and the user-interface mechanism allow a user to drag the handle at least partially along the circular direction of the circle to rotate the image in the image receiving area and to drag the handle at least partially along the radial direction of the circle to change the size of the image.

14. The computer device of claim 13, wherein the display device and the user-interface mechanism allow a user to drag and translate the image in the image receiving area to allow different portions of the image to be viewable in the image receiving area.

15. The computer device of claim 13, wherein the display device is configured to display a delete button to allow a use to remove the image from the image receiving area by touching the delete button.

16. The computer device of claim 13, further comprising a computer processor that is configured to determine the borders of the image at each orientation and position of the image, to compare the borders of the image to the borders of the image receiving area, and to select the size of the image to allow the image receiving area to be fully occupied by a portion of the image.

17. The computer device of claim 16, wherein the computer processor is configured to select size of the image at above a minimum size such that the image receiving area is fully occupied by a portion of the image.
